(19) United States
(12) Patent Application Publication
(10) Pub. No.: US 2010/0250596 A1
(43) Pub. Date: Sep. 30, 2010

(54) Methods and Apparatus for Identifying Conditional Functional Dependencies

(76) Inventors: Wenfei Fan, (US); Ming Xiong, (US)

Correspondence Address: Ryan, Mason & Lewis, LLP, Suite 205, 1300 Post Road, Fairfield, CT, 06824, US

(21) Appl. No.: 12/411,935

(22) Filed: Mar. 26, 2009

(51) Int. Cl. G06F 17/30

(52) U.S. Cl. 707/776; 707/E17.039

(57) ABSTRACT

Methods and apparatus are provided for discovering minimal conditional functional dependencies (CFDs). CFDs extend functional dependencies by supporting patterns of semantically related constants, and can be used as rules for cleaning relational data. A disclosed CFDMiner algorithm, based on techniques for mining closed itemsets, discovers constant minimal CFDs. A disclosed CTANE algorithm discovers general minimal CFDs based on the levelwise approach. A disclosed FastCFD algorithm discovers general minimal CFDs based on a depth-first search strategy, and an optimization technique via closed-itemset mining to reduce search space.

### FIELD OF THE INVENTION

The present invention relates to techniques for discovering conditional functional dependencies (CFDs) and, more particularly, to CFD discovery techniques that reduce the number of discovered redundant CFDs.

### BACKGROUND OF THE INVENTION

Conditional functional dependencies were introduced for data cleaning. See, e.g., W. Fan et al., “Conditional Functional Dependencies for Capturing Data Inconsistencies,” TODS, Vol. 33, No. 2 (June, 2008), incorporated by reference herein. Generally, conditional functional dependencies extend standard functional dependencies (FDs) by enforcing patterns of semantically related constants. CFDs are generally considered more effective than FDs in detecting and repairing inconsistencies of data (often referred to as dirtiness of data). It is expected that conditional functional dependencies will be adopted by data-cleaning tools that currently employ standard FDs (e.g., M. Arenas et al., “Consistent Query Answers in Inconsistent Databases,” TPLP, Vol. 3, No. 4-5, 393-424 (2003) and J. Chomicki and J. Marcinkowski, “Minimal-Change Integrity Maintenance Using Tuple Deletions,” Information and Computation, Vol. 197, Nos. 1-2, 90-121 (2005).

For CFD-based cleaning methods to be effective in practice, however, it is necessary to have techniques to automatically discover or learn CFDs from sample data, to be used as data cleaning rules. Indeed, it is often unrealistic to rely solely on human experts to design CFDs via an expensive and long manual process. It has been suggested that cleaning-rule profiling is critical to commercial data quality tools.

This practical concern highlights the need for studying the discovery problem for CFDs: given a sample instance r of a relation schema R, the discovery problem finds a canonical cover of all CFDs that hold on r (i.e., a set of CFDs that is logically equivalent to the set of all CFDs that hold on r). To reduce redundancy, each CFD in the canonical cover should be minimal (i.e. nontrivial and left-reduced). For a more detailed discussion of nontrivial and left-reduced FDs, see, for example, S. Abiteboul et al., “Foundations of Databases,” Addision-Wesley (1995).

The discovery problem is nontrivial. For example, for traditional FDs, a canonical cover of FDs discovered from a relation r is inherently exponential in the arity of the schema of r (i.e., the number of attributes in R). Since CFD discovery subsumes FD discovery, the exponential complexity carries over to CFD discovery. Moreover, CFD discovery requires mining of semantic patterns with constants, a challenge that was not encountered when discovering FDs.

A number of techniques have been proposed or suggested for discovering CFDs. For example, L. Golab et al., “On Generating Near-Optimal Tableaux for Conditional Functional Dependencies,” VLDB (2008), showed that for a fixed traditional FD, fd, that it is np-complete to find useful patterns that, together with fd, make quality CFDs. L. Golab et al. provide heuristic algorithms for discovering patterns from samples with respect to a fixed FD.

F. Chiang and R. Miller, “Discovering Data Quality Rules,” VLDB (2008), presented an algorithm for discovering CFDs, including both traditional FDs and their associated patterns. The disclosed discovery algorith, however, does not avoid the redundancy of discovered CFDs.

A need therefore exists for improved methods and apparatus for identifying conditional functional dependencies. A further need exists for CFD discovery techniques that reduce the number of discovered redundant CFDs.

### SUMMARY OF THE INVENTION

Generally, methods and apparatus are provided for identifying one or more conditional functional dependencies defined over a schema, R, given a sample relation, r, of said schema, R, and a support threshold, k. Minimal CFDs are disclosed based on both the minimality of attributes and the minimality of patterns. Generally, minimal CFDs contain neither redundant attributes nor redundant patterns. Frequent CFDs are addressed that hold on a sample dataset r, namely, CFDs in which the pattern tuples have a support in r above a certain threshold, k.

A CFDMiner algorithm is disclosed for constant CFD discovery. The connection between minimal constant CFDs and closed and free patterns is explored. CFDMiner finds constant CFDs by leveraging a latest mining technique, which mines closed itemsets and free itemsets in parallel following a depth-first search scheme.

A CTANE algorithm extends TANEF a well-known algorithm for mining FDs, to discover general CFDs. CTANE is based on an attribute-set/pattern tuple lattice, and mines CFDs at level k+1 of the lattice ( i.e., when each set at the level consists of k+1 attributes) with pruning based on those at level k. CTANE discovers only minimal CFDs, and does not return unnecessarily redundant CFDs.

A FastCFD algorithm discovers general CFDs by employing a depth-first search strategy instead of following the levelwise approach. FastCFD is a nontrivial extension of FastFD, an algorithm for FD profiling, by mining pattern tuples. A pruning technique is employed by FastCFD, by leveraging constant CFDs found by CFDMiner.

A more complete understanding of the present invention, as well as further features and advantages of the present invention, will be obtained by reference to the following detailed description and drawings.

### BRIEF DESCRIPTION OF THE DRAWINGS

FIG. 1 is a sample table illustrating an exemplary instance r₀ of a cust relation;

FIG. 2 illustrates the closed sets in the cust relation that contain (CT,(MH)) and their corresponding free sets;

FIG. 3 illustrates exemplary pseudo code for an implementation of the CTANE algorithm;

FIG. 4 illustrates a partial run of the CTANE algorithm involving only attributes CC, AC, ZIP and STR;

FIGS. 5A and 5B, collectively, illustrate exemplary pseudo code for an exemplary implementation of the FindMin algorithm;

FIG. 6 illustrates a partial execution of the FindCover algorithm; and

FIG. 7 is a schematic block diagram of an exemplary CFD discovery system in accordance with the present invention.

### DETAILED DESCRIPTION

The present invention provides methods and apparatus for identifying CFDs. The present invention recognizes that CFDs support patterns of semantically related constants and can be used as rules for cleaning relational data. According to one aspect of the invention, CFD discovery techniques are disclosed that discover minimal CFDs based on both the minimality of attributes and the minimality of patterns. According to another aspect of the invention, a CFD discovery technique, referred to as CFDMiner, is disclosed that is based on mining closed itemsets. The disclosed CFDMiner algorithm can discover constant CFDs with only constant patterns, without paying the price of discovering all CFDs. It has been found that constant CFD discovery is often several orders of magnitude faster than general CFD discovery. Constant CFDs are important for both data cleaning and data integration.

According to yet another aspect of the invention, general minimal CFDs are discovered using a CTANE algorithm based on the levelwise approach or FastCFD algorithm that employs a depth-first approach (which optionally leverages closed-itemset mining to reduce search space).

As previously indicated, CFD discovery requires mining of semantic patterns with constants, as illustrated by the following example.

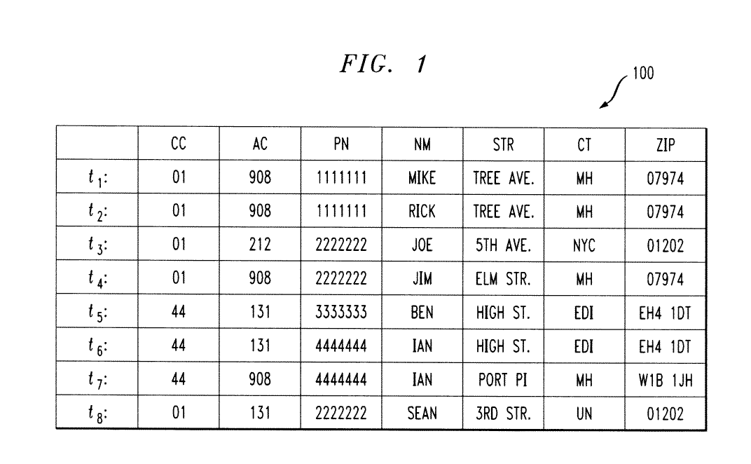

Example 1. The following relational schema cust is taken from W. Fan et al., “Conditional Functional Dependencies for Capturing Data Inconsistencies,” TODS, Vol. 33, No. 2 (June, 2008). The relational schema cust specifies a customer in terms of the customer's phone (country code (CC), area code (AC), phone number (PN)), name (NM), and address (street (STR), city (CT), zip code (ZIP)). FIG. 1 is a sample table 100 illustrating an exemplary instance r₀ of a cust relation.

Traditional FDs that hold on r₀ include the following:

f₁: [CC,AC]→CT

f₂: [CC,AC,PN]43 STR

Here, f₁ requires that two customers with the same country- and area-codes also have the same city (similarly for f₂ ).

In contrast, the CFDs that hold on r₀ include not only the FDs f₁ and f₂, but also the following (and more):

φ₀: ([CC,ZIP]→STR, (44, _∥_))

φ₁: ([CC,AC]→CT, (01, 908∥MH))

φ₂: ([CC,AC]→CT, (44, 131∥EDI))

φ₃: ([CC,AC]→CT, (01, 212∥NYC))

In FD φ₀, (44, _∥_) is the pattern tuple that enforces a binding of semantically related constants for attributes (CC, ZIP, STR) in a tuple. FD φ₀ states that for customers in the United Kingdom, the zip code (ZIP) uniquely determines the street (STR). FD φ₀ is an FD that only holds on the subset of tuples with the pattern “CC=44,” rather than on the entire relation r₀. CFD φ₁ ensures that for any customer in the United States (country code 01) with area code 908, the city of the customer must be Murray Hill (MH), as enforced by its pattern tuple (01, 908∥MH) (similarly for φ₂ and φ₃). These conditional functional dependencies cannot be expressed as FDs.

More specifically, a CFD is of the form (X→A,tₚ), where X→A is an FD and tₚ is a pattern tuple with attributes in X and A. The pattern tuple consists of constants and an unnamed variable ‘_’ that matches an arbitrary value. To discover a CFD, it is necessary to find not only the traditional FD, X→A, but also its pattern tuple tₚ. With the same FD, X→A, there are possibly multiple CFDs defined with different pattern tuples (e.g., φ₀-φ₃). Hence, a canonical cover of CFDs that hold on r₀ is typically much larger than its FD counterpart. Indeed, it was recently shown that provided a fixed FD, X→A, is already given, the problem for discovering sensible patterns associated with the FD alone is NP-complete.

It is noted that the pattern tuple in each of φ₁-φ₃ consists of only constants in both its left-hand-side (LHS) and right-hand-side (RHS). Such CFDs are referred to as constant CFDs. Constant CFDs are instance-level FDs that are particularly useful in object identification, an issue essential to both data quality and data integration.

Three exemplary algorithms are provided for CFD discovery: one algorithm for discovering constant CFDs, and the other two algolithms for general CFDs.

(1) A notion of minimal CFDs is disclosed based on both the minimality of attributes and the minimality of patterns. Intuitively, minimal CFDs contain neither redundant attributes nor redundant patterns. Frequent CFDs are addressed that hold on a sample dataset r, namely, CFDs in which the pattern tuples have a support in r above a certain threshold. Frequent CFDs accommodate unreliable data with errors and noise. The disclosed algorithms find minimal and frequent CFDs to help users identify quality cleaning rules from a possibly large set of CFDs that hold on the samples.

(2) A first algorithm, referred to as CFDMiner, is for constant CFD discovery. The connection between minimal constant CFDs and closed and free patterns is explored. Based on this, CFDMiner finds constant CFDs by leveraging a latest mining technique proposed in J. Li et al., “Mining Statistically Important Equivalence Classes and Delta-Discriminative Emerging Patterns,” KDD (2007), incorporated by reference herein, which mines closed itemsets and free itemsets in parallel following a depth-first search scheme.

(3) A second algorithm, referred to as CTANE, extends TANE, a well-known algorithm for mining FDs, to discover general CFDs. CTANE is based on an attribute-set/pattern tuple lattice, and mines CFDs at level k+1 of the lattice ( i.e., when each set at the level consists of k+1 attributes) with pruning based on those at level k. CTANE discovers minimal CFDs only, and does not return unnecessarily redundant CFDs found by the TANE-extension of F. Chiang and R. Miller, referenced above.

(4) A third algorithm, referred to as FastCFD, discovers general CFDs by employing a depth-first search strategy instead of following the levelwise approach. FastCFD is a nontrivial extension of FastFD, an algorithm for FD profiling, by mining pattern tuples. A novel pruning technique is introduced by FastCFD, by leveraging constant CFDs found by CFDMiner. As opposed to CTANE, FastCFD does not take exponential time in the arity of sample data when a canonical cover of CFDs is not exponentially large.

It has been found that CFDMiner often outperforms CTANE and FastCFD by three orders of magnitude. It has also been found that FastCFD scales well with the arity: it is up to three orders of magnitude faster than CTANE when the arity is between 10 and 15, and it performs well when the arity is greater than 30; in contrast, CTANE may not run to completion when the arity is above 17. On the other hand, CTANE is more sensitive to support threshold and outperforms FastCFD when the threshold is large and the arity is of a moderate size. It has also been found that the disclosed pruning techniques via itemset mining are effective: it improves the performance of FastCFD by a factor of 5-10 and makes FastCFD scale well with the sample size.

These results provide a guideline for when to use CFDMiner, CTANE or FastCFD in different applications. For example, when only constant CFDs are needed, one can use CFDMiner without paying the price of mining general CFDs. CFDMiner can be multiple orders of magnitude faster than CTANE and FastCFD for constant CFD profiling. CTANE usually works well when the arity of a sample relation is small and the support threshold is high, but it scales poorly when the arity of a relation increases. When the arity of a sample dataset is large, FastCFD can be employed. NaiveFast and FastCFD are more efficient than CTANE when the arity of the relation is large. Thus, when k-frequent CFDs are needed for a large k, one could use CTANE. The disclosed optimization technique based on closed-itemset mining is effective: FastCFD significantly outperforms NaiveFast, especially when the arity is large.

Conditional Functional Dependencies

Consider a relation schema R defined over a fixed set of attributes, denoted by attr(R). For each attribute A ε attr(R), dom(A) denotes its domain.

A conditional functional dependency (CFD) φ over R is a pair (X→A,tₚ), where (1) X is a set of attributes in attr(R), and A is a single attribute in attr(R), (2) X→A is a standard FD, referred to as the FD embedded in φ; and (3) tₚ is a pattern tuple with attributes in X and A, where for each B in X ∪ {A}, tₚ[B] is either a constant ‘a’ in dom(B), or an unnamed variable ‘_’ that draws values from dom(B).

X is denoted as LHS(φ) and A as RHS(φ). If A also occurs in X, A_{L} and A_{R} indicate the occurrence of A in the LHS(φ) and RHS(φ), respectively. The X and A attributes are separated in a pattern tuple with ‘∥’.

Standard FDs are a special case of CFDs. Indeed, an FD X→A can be expressed as a CFD (X→A,tₚ), where tₚ[B]=_ for each B in X ∪ {A}.

Example 2. The FD f₁ of Example 1 can be expressed as a CFD ([CC, AC]→CT, (_, _∥_); similarly for f₂. All of f₁,f₂ and φ₀-φ₃ are CFDs defined over schema cust. For φ₀, for example, LHS(φ₀) is [CC,ZIP] and RHS(φ₀) is STR.

To give the semantics of CFDs, an order ≦ is defined on constants and the unnamed variable ‘_’: η₁≦η₂ if either η₁=η₂, or η₁ is a constant a and η₂ is ‘_’.

The order ≦ naturally extends to tuples, e.g., (44, “EH4 1DT”, “EDI”)≦(44, _, _) but (01, 07974, “Tree Ave.”) ≦ (44, _, _). A tuple t₁ matches t₂ if t₁≦t₂. We write t₁<<t₂ if t₁≦t₂ but t₂≦t₁, i.e., when t₂ is “more general” than t₁. For instance, (44, “EH4 1DT”, “EDI”)<<(44, _,_).

An instance r of R satisfies the CFD φ (or φ holds on r), denoted by r|=φ, if and only if (iff) for each pair of tuples t₁,t₂ in r, if t₁[X]=t₂[X]≦tₚ[X] then t₁[A]=t₂[A]≦tₚ[A]. Intuitively, φ is a constraint defined on the set r_{φ}={t|t ε r,t[X]≦tₚ[X]} such that for any t₁,t₂ ε r_{φ}, if t₁[X]=t₂[X], then (a) t₁[A]=t₂[A], and (b) t₁[A]≦tₚ[A]. Here (a) enforces the semantics of the embedded FD on the set r_{φ}, and (b) assures the binding between constants in tₚ[A] and constants in t₁[A]. That is, φ constrains the subset r_{φ} of r identified by tₚ[X], rather than the entire instance r.

Example 3. The instance r₀ of FIG. 1 satisfies CFDs f₁,f₂ and φ₀-φ₃ of Example 1. The instance r₀ does not satisfy the CFD ψ=([CC,ZIP]→STR, (_, _,∥_)). Indeed, t₁ and t₄ violate ψ since t₁[CC, ZIP]=t₄[CC, ZIP]≦(_, _), but t₁[STR] ≠ t₄[STR]. or does r satisfy ψ′=(AC→CT, (131∥EDI)) since t₈ violates ψ′: t₈[AC]≦(131) but t₈[CT]≦(EDI). From this, it can be seen that while two tuples are needed to violate an FD, CFDs can be violated by a single tuple.

An instance r of R satisfies a set Σ of CFDs over R, denoted by r|=Σ, if r|=φ for each CFD φ ε Σ.

For two sets Σ and Σ′ of CFDs defined over the same schema R, Σ is equivalent to Σ′, denoted by Σ≡Σ′, iff for any instance r of R, r|=Σ iff r|=Σ′.

CFDs can also be defined as (X→Y,tₚ), where Y is a set of attributes and X→Y is an FD. As in the case of FDs, such a CFD is equivalent to a set of CFDs with a single attribute in their RHS.

A CFD (X→A,tₚ) is called a constant CFD if its pattern tuple tₚ consists of constants only, i.e., tₚ[A] is a constant and for all B ε X, tₚ[B] is a constant. A CFD is called a variable CFD if tₚ[A]=_, i.e., the RHS of its pattern tuple is the unnamed variable ‘_’.

Example 4. Among the CFDs given in Example 1, f₁,f₂,φ₀ are variable CFDs, while φ₁,φ₂,φ₃ are constant CFDs.

It has been shown that any set Σ of CFDs over a schema R can be represented by a set Σ_{c} of constant CFDs and a set Σᵥ of variable CFDs, such that Σ≡Σ_{c} ∪ Σᵥ. In particular, for a CFD φ=(X→A,tₚ), if tₚ[A] is a constant a, then there is an equivalent CFD φ′=(X′→A, (tₚ[X′]∥a)), where X′ consists of all attributes B ε X such that tₚ[B] is a constant. That is, when tₚ[A] is a constant, all attributes B can be dropped in the LHS of φ with tₚ[B]=‘_’.

Lemma 1: For any set Σ of CFDs over a schema R, there exist a set Σ_{c} of constant CFDs and a set Σᵥ of variable CFDs over R, such that Σ is equivalent to Σ_{c} ∪ Σᵥ.

Discovery of CFDs

Given a sample relation r of a schema R, an algorithm for CFD discovery aims to find CFDs defined over R that hold on r. The set of all CFDs that hold on r should not be returned, since the set contains trivial and redundant CFDs and is unnecessarily large. Thus, a canonical cover is desired, i.e., a non-redundant set consisting of minimal CFDs only, from which all CFDs on r can be derived via implication analysis. Moreover, real-life data is often dirty, containing errors and noise. To exclude CFDs that match errors and noise only, frequent CFDs are considered, which have a pattern tuple with support in r above a threshold.

The notions of minimal CFDs and frequent CFDs are formalized before stating the discovery problem for CFDs.

Minimal CFDs. A CFD φ=(X→A,tₚ) over R is said to be trivial if A ε X . If φ is trivial, then either it is satisfied by all instances of R (e.g., when tₚ[A_{L}]=tₚ[A_{R}]), or it is satisfied by none of the instances in which there is a tuple t such that t[X]≦tₚ[X] ( e.g., if tₚ[A_{L}] and tₚ[A_{R}] are distinct constants). A constant CFD (X→A, (tₚ∥a)) is said to be left-reduced on r if for any Y [symbol] X, r|≠(Y→A, (tₚ[Y]∥a)).

A variable CFD (X→A, (tₚ∥_)) is left-reduced on r if (1) r|≠(Y→A,(tₚ[Y]∥_)) for any proper subset Y [symbol] X, and (2) r|≠(X→A,(tₚ′[X]∥_)) for any tₚ′ with tₚ<<tₚ′. Intuitively, these requirements ensure the following: (1) none of its LHS attributes can be removed, i.e., the minimality of attributes, and (2) none of the constants in its LHS pattern can be “upgraded” to ‘_’, i.e., the pattern tₚ[X] is “most general”, or in other words, the minimality of patterns. A minimal CFD φ on r is a nontrivial, left-reduced CFD such that r|−φ. Intuitively, a minimal CFD is non-redundant.

Example 5. On the sample r₀ of FIG. 1, φ₂ of Example 1 is a minimal constant CFDs, and f₁,f₂ and φ₀ are minimal variable CFDs. However, φ₃ is not minimal: if CC is dropped from LHS(φ₃), r₀ still satisfies (AC→CT, (212∥NYC)) since there is only one tuple (t₃) with AC=212 in r₀. Similarly, φ₁ is not minimal since CC can be dropped.

Consider CFDs f₁¹=(f₁,(01,_∥_)), f₁²=(f₁,(44,_∥_)), f₁³=(f₁,(_{—},908∥_)), f₁⁴=(f₁,(_{—},212∥_)), and f₁⁵=(f₁,(_{—},311∥_)). While these CFDs hold on r₀, they are not minimal CFDs, since they do not satisfy requirement (2) for left-reduced variable CFDs. Indeed, (f₁,(_,_∥_)) is a minimal CFD on r₀ with a pattern more general than any of f₁ⁱ for i ε [1,5]; in other words, these f₁ⁱ's are redundant.

Frequent CFDs. The support of a CFD φ=(X→A,tₚ) in r, denoted by sup(φ,r), is defined to be the set of tuples t in r such that t[X]≦tₚ[X] and t[A]≦tₚ[A], i.e., tuples that match the pattern of φ. For a natural number k≧1, a CFD φ is said to be k-frequent in r if sup(φ,r)≧k. For instance, φ₁,φ₂ of Example 1 are 3-frequent and 2-frequent, respectively. Moreover, f₁,f₂ are 8-frequent.

It is noted that the notion of frequent CFDs is quite different from the notion of approximate FDs. An approximate FD ψ on a relation r is an FD that “almost” holds on r, i.e., there exists a subset r′ ⊂ r such that r′|=ψ and the error |r\r′|/|r| is less than a predefined bound. It is not necessary that r|=ψ. In contrast, a k-frequent CFD φ in r is a CFD that must hold on r, i.e., r|=φ, and moreover, there must be sufficiently many (at least k) witness tuples in r that match the pattern tuple of φ.

A canonical cover of CFDs on r with respect to k is a set Σ of minimal, k-frequent CFDs in r, such that Σ is equivalent to the set of all k-frequent CFDs that hold on r. Given an instance r of a relation schema R and a support threshold k, the discovery problem for CFDs is to find a canonical cover of CFDs on r with respect to k. Intuitively, a canonical cover consists of non-redundant frequent CFDs on r, from which all frequent CFDs that hold on r can be inferred.

Discovering Constant CFDs

According to one aspect of the present invention, a CFDMiner algorithm is provided for constant CFD profiling. Given an instance r of R and a support threshold k, CFDMiner finds a canonical cover of k-frequent minimal constant CFDs of the form (X→A,(tₚ∥a)).

The exemplary CFDMiner algorithm is based on the connection between left-reduced constant CFDs and free and closed itemsets. A similar relationship was established for so-called non-redundant association rules. In that context, left-reduced constant CFDs coincide with non-redundant association rules that have 100% confidence and have a single attribute in their antecedent.

Free and Closed Itemsets. An itemset is a pair (X,tₚ), where X ⊂ attr(R) and tₚ is a constant pattern over X. Given an instance r of the schema R, the support of (X,tₚ) in r, denoted by supp(X,tₚ,r), is defined as the set of tuples in r that match with tₚ on the X-attributes. (Y,sₚ) is more general than (X,tₚ) denoted by (X,tₚ)≦(Y,sₚ), if Y ⊂ X and tₚ[Y]=sₚ. Furthermore, (Y,sₚ) is strictly more general than (X,tₚ) denoted by (X,tₚ)<(Y,sₚ), if Y ⊂ X and tₚ[Y]=sₚ. Clearly, if (X,tₚ)≦(Y,sₚ) then supp(X,tₚ,r) ⊂ supp(Y,sₚ,r). For a natural number k≧1, an itemset (X,tₚ) is k-frequent if |supp(X,tₚ,r)|≧k.

An itemset (X,tₚ) is closed in r if there exists no itemset (Y,sₚ) such that (Y,sₚ)≦(X,tₚ) for which supp(Y, sₚ,r)=supp(X,tₚ,r). Intuitively, a closed itemset (X,tₚ) cannot be extended without decreasing its support. For an itemset (X,tₚ), clo(X,tₚ) denotes the unique closed itemset that extends (X,tₚ) and has the same support in r as (X,tₚ).

Similarly, an itemset (X,tₚ) is called free in r if there exists no itemset (Y,sₚ) such that (X,tₚ)≦(Y,sₚ) for which supp(Y,sₚ,r)=supp(X,tₚ,r). Intuitively, a free itemset (X,tₚ) cannot be generalized without increasing its support.

A closed (resp. free) itemset (X,tₚ) is k-frequent if the itemset (X,tₚ) is k-frequent and closed (resp. free).

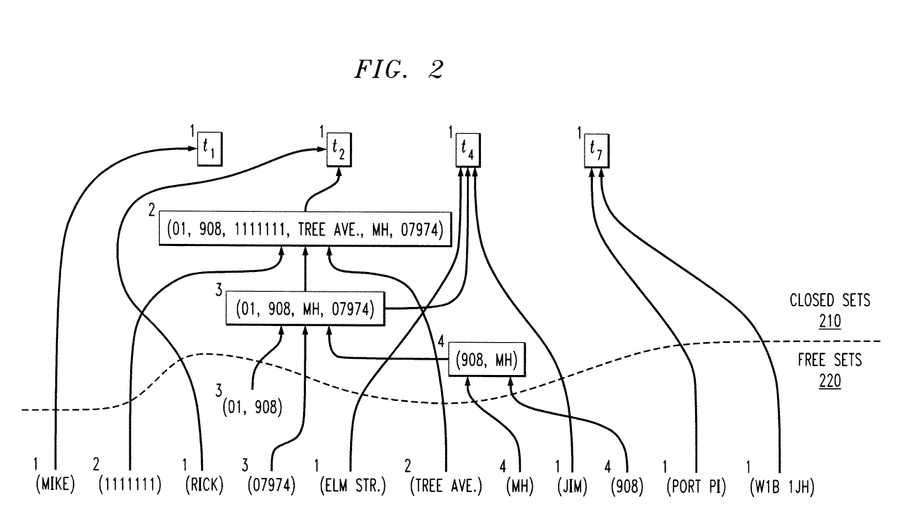

FIG. 2 illustrates the closed sets 210 in the cust relation that contain (CT,(MH)) and their corresponding free sets 220 (closed sets are enclosed in a rectangle). To simplify FIG. 2, the attribute names in the itemsets are not shown. FIG. 2 also illustrates the size of the support of the itemsets. For example, ([CC, AC, CT, ZIP], (01, 908, MH, 07974)) is a closed itemset with support equal to three. This itemset has two free patterns, ([CC, AC], (01, 908)) and ([ZIP],(07974)), both having support equal to three as well.

The connection between k-frequent free and closed itemsets and k-frequent left-reduced constant CFDs is as follows.

Proposition 1. For an instance r of R and any k-frequent left-reduced constant CFDφ=(X→A,(tₚ∥a)), r|=φ iff (i) the itemset (X,tₚ) is free, k-frequent and it does not contain (A,a); (ii) clo(X,tₚ)≦(A,a); and (iii) (X,tₚ) does not contain a smaller free set (Y,sₚ) with this property, i.e., there exists no (Y,sₚ) such that (X,tₚ)≦(Y,sₚ), Y [symbol] X, and clo(Y,sₚ)≦(A,a).

From proposition 1 and the closed and free itemsets 210, 220 shown in FIG. 2, it follows that there are only four possible φ₁: ([CC,AC]→CT, (01, 908∥MH)) of Example 1 is a 3 -frequent constant CFD that holds on the cust relation. Indeed, it is obtained from the closed pattern ([CC, AC, CT, ZIP], (01, 908, MH, 07974)), where the free pattern ([CC, AC], (01, 908)) is taken as the LHS of the constant CFD, FIG. 2, however, shows that this LHS contains a smaller free set (AC, (908)) whose closed set ([AC, CT], (908, MH)) contains (CT, (MH)). Hence, φ₁ is not left-reduced. It can be verified that (AC→CT, (908∥MH)) is a 3 -frequent left-reduced constant CFD on cust. One can see that φ₂ and φ₃, given in Example 1 can be obtained in a similar way (although one has to consider closed patterns that contain (CT,(EDI)) for φ₂).

CFDMiner. Proposition 1 forms the basis for the constant CFD discovery algorithm. Suppose that for a given instance r and a support threshold k, all k-frequent closed sets and their corresponding k-frequent free sets are available. As mentioned above, there have been various algorithms that provide these sets. The exemplary embodiment employs the GCGROWTH algorithm (H. Li et al., “Relative Risk and Odds Ratio: A Data Mining Perspective,” PODS, 2005, incorporated by reference herein) because, in contrast to other algorithms, the algorithm simultaneously discovers closed sets and their free sets.

Generally, GCGROWTH returns a mapping C2F that associates with each k-frequent closed itemset its set of k-frequent free itemsets. Given this mapping, the disclosed CFDMiner algorithm works as follows: For each k-frequent closed itemset (X,tₚ) its free sets, as given by C2F, are added to a hash table H. Furthermore, when considering the closed itemset (X,tₚ), the itemset RHS(Y,sₚ)=(X\Y,tₚ[X\Y]) is associated with each of its free itemsets (Y,sₚ). That is, each free set is associated with the candidate RHS attributes in their corresponding constant CFDs. During this process, an ordered list L of all k-frequent free itemsets is constructed as well. Itemsets in this list are ordered in ascending order with respect to their sizes. Finally, CFDMiner goes through the list L. When considering the free itemset (Y,sₚ), CFDMiner replaces RHS(Y,sₚ) with RHS(Y,sₚ)∩ RHS(Y′,sₚ[Y′]) for each subset Y′Y such that (Y′,sₚ[Y′]) ε L. Indeed, Proposition 1 implies that only those elements in RHS(Y,sₚ) can lead to a left-reduced constant CFD that are not already included in some RHS(Y′,sₚ[Y′]) of one of its sub-itemsets. It is important to remark that the subset checking can be done efficiently by leveraging the hash-table H. After all subsets of (Y,sₚ) are checked, CFDMiner outputs the corresponding k-frequent constant CFD(Y→A,(sₚ∥a) for all (A,a) ε RHS(Y,sₚ) and moves on to the next element in L.

CTANE: A Levelwise Algorithm

According to another aspect of the invention, a CTANE levelwise algorithm is provided for discovering minimal, k-frequent CFDs. CTANE is an extension of the TANE algorithm for discovering FDs. See, e.g., Y. Huhtala, “TANE: An Efficient Algorithm for Discovering Functional and Approximate Dependencies,” Comput. J. Vol. 42, No. 2, 100-111 (1999), incorporated by reference herein.

CTANE mines CFDs by traversing an attribute-set/pattern lattice L in a levelwise way. More precisely, the lattice L consists of elements of the form (X,tₚ), where X ⊂ attr(R) and tₚ is a pattern tuple over X. The patterns now consist of both constants and unnamed variables (_). (Y,sₚ) is more general than (X,tₚ) if Y ⊂ X and tₚ[Y]<<sₚ. This relationship defines the lattice structure on the attribute-set/pattern pairs.

CTANE for mining 1-frequent minimal CFDs is described first, followed by a discussion of how to modify CTANE to discover k-frequent minimal CFDs for a support threshold k.

CTANE starts from singleton sets (A,α) for A ε attr(R) and α ε dom(A) ∪ {_}. CTANE then proceeds to larger attribute-set/pattern levels in L. When CTANE considers (X,sₚ), it tests for CFDs (X\{A}→A,(sₚ[X\{A}]∥sₚ[A])), where A ε X. This guarantees that only non-trivial CFDs are considered. Furthermore, CTANE maintains for each considered element (X,sₚ) a set, denoted by C⁺(X,sₚ), that is used to determine whether CFD(X\{A}→A,(sₚ[X \{A}]∥sₚ[A])) is minimal. The set C⁺(X,sₚ), as will be explained in more detail below, can be maintained during the levelwise traversal. Apart from testing for minimality, C⁺(X,sₚ) also provides an effective pruning strategy, making the levelwise approach feasible in practice.

Pruning Strategy. TANE's pruning strategy is extended herein. For each element (X,sₚ) in L, a set C⁺(X,sₚ) is provided that consists of elements (A,c_{A}) ε attr(R)×{dom(A) ∪{_}}, satisfying the following conditions: (i) if A ε X, then c_{A}=sₚ[A]; (ii) for all B ε X, r|≠(X\{A,B}→B,(sₚ[X\{A,B}]∥sₚ[B])); and (iii) for all B ε X\{A}, r|≠(X\{A}→A,(sₚ^{B}∥c_{A})), where sₚ^{B}[C]=sₚ[C] for all C≠B and sₚ^{B}[B]=_. Intuitively, condition (i) prevents the creation of inconsistent CFDs; condition (ii) ensures that the LHS cannot be reduced; and finally, condition (iii) ensures that the pattern tuple is most general.

Lemma 2: Let X ⊂ attr(R), sₚ be a pattern over X, A ε X and assume that r|=φ=(X\{A}→A,(sₚ[X\{A}]∥sₚ[A])). Then φ is minimal iff for all B ε X, (A,sₚ[A]) ε C⁺(X\{B},sₚ,[X\{B}]).

In terms of pruning, Lemma 2 says that any element (X,sₚ) of L for which C⁺(X,sₚ)=θ need not be considered. Moreover, if C⁺(X,sₚ)=θ then also C⁺(Y,tₚ)=θ for any (Y,sₚ) that contains (X,tₚ) in the lattice. Therefore, the emptiness of C⁺(X,sₚ) potentially prunes away a large part of elements in L that otherwise need to be considered by CTANE.

Algorithm CTANE.

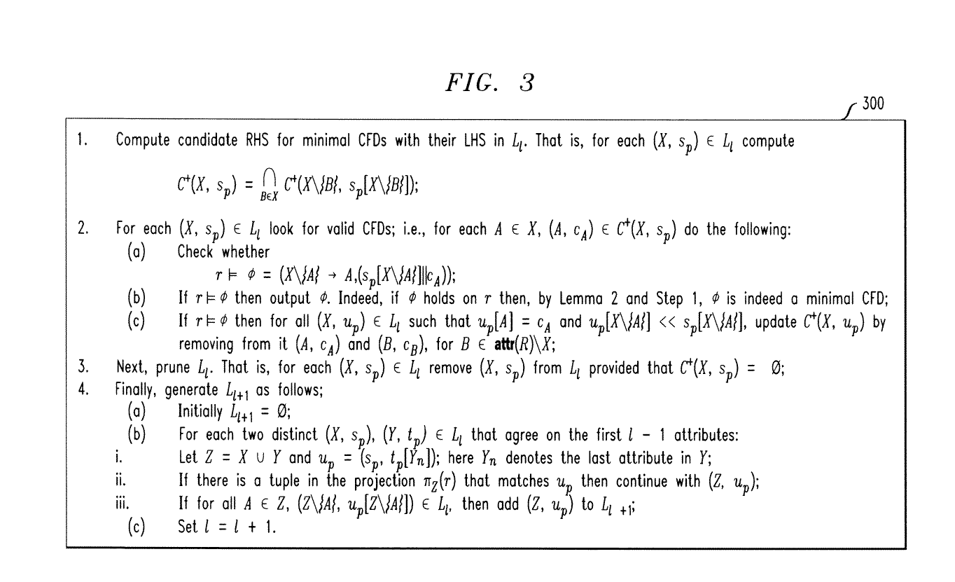

FIG. 3 illustrates exemplary pseudo code 300 for an exemplary implementation of the CTANE algorithm. Lₗ denotes a collection of elements (X,sₚ) in L of size l, i.e., |X|=l. It is assumed that Lₗ is ordered such that (X,sₚ) appears before (Y,tₚ) if X=Y and tₚ<<sₚ. Initially, L₁=(A,_)|A ε attr(R)}∪{(A,a₁)|a₁ ε π_{A}(r), A ε attr(R)}, C⁺(θ)=L₁ and l=1. The steps shown in FIG. 3 are executed as long as Lₗ is non-empty.

As shown in FIG. 3, the exemplary CTANE algorithm:

1. Computes candidate RHS for minimal CFDs with their LHS in Lₗ. That is, for each (X,sₚ) ε Lₗ compute

$${C}^{+} ( X , {s}_{p} ) = {⋂}_{B ∈ X} {C}^{+} ( X \backslash \{ B \} , {s}_{p} [ X \backslash \{ B \} ] ) ;$$

2. For each (X,sₚ) ε Lₗ look for valid CFDs; i.e. for each A ε X, (A,c_{A}) ε C⁺(X,sₚ) do the following:

(a) Check whether

r|=φ=(X\{A}→A,(sₚ[X\{A}]∥c_{A}));

(b) If r|=φ then output φ. Indeed, if φ holds on r then, by Lemma 2 and Step 1, φ is indeed a minimal CFD;

(c) If r|=φ then for all (X,uₚ) ε Lₗ such that uₚ[A]=c_{A} and uₚ[X\{A}]<<sₚ[X\{A}], update C⁺(X,uₚ) by removing from it (A,c_{A}) and (B,c_{B}), for B ε attr(R)\X;

3. Next, prune Lₗ. That is, for each (X,sₚ) ε Lₗ remove (X,sₚ) from Lₗ provided that C⁺(X,sₚ)=θ:

4. Finally, generate Lₗ₊₁ as follows:

(a) Initially Lₗ₊₁=θ;

(b) For each two distinct (X,sₚ),(Y,tₚ) ε Lₗ that agree on the first l−1 attributes:

i. Let Z=X ∪ Y and uₚ=(sₚ,tₚ[Yₙ]); here Yₙ denotes the last attribute in Y;

ii. If there is a tuple in the projection π_{Z}(r) that matches uₚ then continue with (Z,uₚ);

iii. If for all A ε Z, (Z\{A},uₚ[Z\{A}]) ε Lₗ, then add (Z,uₚ) to Lₗ₊₁;

(c) Set l=l+1.

Lemma 2 ensures that Steps 1 and 2(a) correctly generate minimal CFDs. It is easily verified that Steps 1 and 2(c) correctly update C⁺(X,sₚ):

Lemma 3: Suppose that for all (Y,tₚ) ε Lₗ, C⁺(Y,tₚ) is correctly computed. Then, steps 1 and 2(c) in FIG. 3 correctly compute C⁺(X,sₚ) for all (X,sₚ) ε Lₗ₊₁.

CTANE for finding k-frequent CFDs. CTANE can be modified such that it only discovers k-frequent minimal CFDs. First, observe the following: Let φ=(X→A,(tₚ,c_{A})) be a CFD that holds on r. (X^{c},tₚ^{c}) denotes the itemset consisting of the constant part of (X,tₚ). Then φ is k-frequent iff supp(X^{c},tₚ^{c},r)≧k when X≠θ and |r|≧k. This indicates that for any reasonable choice of k (i.e., smaller than the size of r), only the elements (X,sₚ) ε Lₗ need to be restricted to elements for which (X^{c},sₚ^{c}) is a k-frequent itemset. This can be achieved by (1) initializing L₁ to L₁={(A,_)|A ε attr(R)}∪ {(A,a₁)|supp(A,a₁,r)≧k,A ε attr(R)}; and (2) by replacing Step 4.b(ii) in CTANE by a step that only considers (Z,uₚ) if supp(Z^{c},uₚ^{c},r)≧k. Both modifications increase the amount of pruning, and thus improve the efficiency of CTANE when finding k-frequent CFDs.

Generally, there are four primary computational aspects important for an efficient implementation: (i) the maintenance of the sets C⁺(X,sₚ) (Step 1); (ii) the validation of the candidate minimal CFDs(Step 2.b); (iii) the generation of Lₗ₊₁ (Step 4); and (iv) the checking of support when discovering k-frequent CFDs(Step 4.b(ii)). The technique underlying (i) and (ii) is based on so-called partitions. More specifically, given (X,sₚ), two tuples u, v ε r are equivalent with respect to (X,sₚ) if u[X]=v[X]≦sₚ[X]. Any (X,sₚ) therefore induces an equivalence relation on a subset of r. If [u]_{(X,s}_{ₚ}₎ denotes the set of tuples in r that are equivalent with u, then π_{(X,s}_{ₚ}₎={[u]_{(X,s}_{ₚ}₎|u ε r} can be used to partition a subset of r under (X,sₚ). The validity of a CFD φ=(X→A,(sₚ∥c_{A})) in r can now be tested by checking whether |π_{(X,s}_{ₚ}₎|=|π_{([X,A],(s}_{ₚ}_{,c}_{_{A}}₎₎|. That is, the number of equivalence classes should be the same. It is this characterization of the validity of a CFD that provides an efficient implementation of (ii). Moreover, π_{(X,s}_{ₚ}₎ can be used to eliminate redundant elements in C⁺(X,sₚ), making this list as small as possible. In contrast, a naive implementation of Step 1 might keep around potential elements that never appear together with (X,sₚ) in r. Regarding (iii), similar techniques as in TANE are used to generate partitions corresponding to elements in Lₗ₊₁ as the product of previously computed partitions. Moreover, for the generation of the elements in Lₗ₊₁, elements are stored in Lₗ lexicographically, and from this, one can efficiently generate candidate patterns (Z,uₚ). Finally, when considering k-frequent CFDs, partitions can be used efficiently to check the support of a newly created element (Z,uₚ) in Step 4.b(ii). Moreover, when (Z,uₚ) is obtained from X ∪ Y and uₚ=(sₚ,tₚ[Yₙ]) with tₚ[Yₙ]=_, then we can avoid checking supp(Z^{c},uₚ^{c},r) altogether. Indeed, the support of this pattern is equal to the support of supp(X,sₚ,r) which is assumed to be k-frequent already since it must belong to Lₗ (Step 4.b(iii)).

Consider again the cust relation of FIG. 1. FIG. 4 illustrates a partial run of the CTANE algorithm involving only attributes CC, AC, ZIP and STR. Assume a support threshold k≧3.

FIG. 4 illustrates the first two levels of lattice L and the third level corresponding to attributes [CC,AC,ZIP]. In particular, for each element (X,sₚ) inspected by CTANE, the attribute set X is listed together with the list of possible patterns, ranked with respect to the number of ‘_’ in them.

As shown in FIG. 4, certain points during the execution of CTANE are highlighted:

(A) Initially Lₗ consists of all single attribute/value pairs that appear at least k times, and each attribute occurs together with an unnamed variable. Note that k limits the number of values dramatically for, e.g., the STR attribute. At this point, all sets C⁺(A,c_{A}) contain (A,c_{A}). Since r does not satisfy any CFD with an empty LHS, none of the C⁺-sets is updated in Step 2. Similarly, none of the sets is removed from L₁ in Step 3.

(B) In Step 4, CTANE pairs attributes together and creates consistent patterns. Note that for (CC,AC) the constant 44 does not appear anywhere (while it did at the lower level), because k=3.

(C) For the gray shaded patterns, Step 2 finds valid CFDs: (ZIP→CC,(07974∥_)), (ZIP→CC,(07974∥01)), (ZIP→AC,(07974∥_)), (ZIP→AC,(07974∥908)), and (STR→ZIP,(_∥_)). This implies that, e.g., C⁺([CC,ZIP],(_{—},07974)) and C⁺([AC,ZIP],(_{—},07974)) are updated in Step 2 by removing (CC,_) and (AC,_), respectively.

(D) Step 4 now creates triples of attributes. Only the patterns for (CC,AC,ZIP) are shown. In Step 2, CTANE finds the CFD([CC,AC]→ZIP,(_,_∥_)).

(E) As a result, CTANE updates the C⁺-sets in Step 2.c, not only of the current pattern but also of those with a more specific pattern on the LHS-attributes. That is, (ZIP,_) is removed from the C⁺-set from the first three patterns. This ensures that CFDs to be generated later only have the most general LHS-pattern.

(F) Finally, in Step 1 of CTANE, the C⁺ set of the pattern tuple (_,_{—},07974) is computed. However, recall that both C⁺([CC,ZIP],(_{—},07974)) and C⁺([AC,ZIP],(_{—},07974)) have been updated. As a result, neither (CC,_) nor (AC,_) will be included in the C⁺-set of (_,_{—},07974). This illustrates that the only chance of finding a minimal CFD in this case is to test ([AC,CC]→ZIP, (_,₁₃ ∥07974)), which in this case does not hold on r. However, this shows that the C⁺-sets indeed reduce the possible RHS for candidate minimal CFDs.

FastCFD: A Depth First Approach

According to another aspect of the invention, a FastCFD algorithm is provided as an alternative algorithm for discovering minimal CFDs. Given an instance r and a support threshold k, FastCFD finds a canonical cover of all minimal CFDs φ such that sup(φ,r)k. In contrast to the breadth-first approach of CTANE, FastCFD discovers k-frequent minimal CFDs in a depth-first way. It is inspired by FastFD, a depth-first algorithm for discovering FDs.

Consider X ⊂ attr(R) and an attribute A in attr(R)\X. fixlhs(X,A,r,k) denotes the set of all CFDsφ=(Y→A,tₚ) such that Y ⊂ X, φ is minimal, and moreover sup(φ,r)k. All k-frequent CFDs in r can therefore be found by computing [symbol] _{Aεattr(R)} fixlhs(attr(R)\{A},A,r,k). Algorithm FastCFD does this: for each A ε attr(R), it calls a procedure FindCover that computes fixlhs(attr(R)\{A},A,r,k). The remainder of this section is devoted to the description of the procedure FindCover.

Difference sets. To compute fixlhs(attr(R)\{A},A,r,k) in a depth-first way, a difference set is defined for a pair of tuples t₁,t₂ ε r by D(t₁,t₂;r)={B ε attr(R)|t₁[B]≠t₂[B]}, i.e., the set of attributes in which t₁ and t₂ differ. The difference set of r is D(r)={D(t₁,t₂;r)|t₁,t₂ ε r}.

\hat{D}_{A}(r) denotes the set {Y\{A}|Y ε D(r), A ε Y}, i.e., the set of attribute sets Y\{A} such that there exist tuples in r that disagree on all of the attributes in Y, including A. Furthermore, D_{A}(r)={Y ε \hat{D}_{A}(r)|(Y′ ε \hat{D}_{A}(r))̂(Y′ ⊂ Y [symbol] Y′=Y)} denotes the minimal difference sets of \hat{D}_{A}(r).

Let Z ⊂ attr(R) and X ⊂ P(attr(R)) (i.e.,the power set of attr(R)). Z covers X iff ∀ Y ε X, Y ∩ Z≠θ. Furthermore, Z is a minimal cover for X in case no Z′ ⊂ Z covers X.

The relationship between difference sets and the validity of CFDs is revealed by Lemma 4. For a pattern tₚ, rₜ_{ₚ} denotes the set of tuples in r that match with tₚ.

Lemma 4: Given a constant CFDφ=(X→A,(tₚ∥a)), then r|=φ and sup(φ,r)≧k iff |rₜ_{ₚ}|≧k and D_{A}(rₜ_{ₚ})=θ. Given a variable CFDφ=(X→A,(tₚ∥_)), then r|=φ and sup(φ,r)≧k iff |rₜ_{ₚ}|≧k and X covers D_{A}(rₜ_{ₚ}).

Lemma 4 forms the basis for finding minimal k-frequent CFDs. First, to find a minimal k-frequent constant CFD(X→A,(tₚ∥a)) a k-frequent itemset (X,tₚ) in r must be found such that D_{A}(rₜ_{ₚ})=θ and D_{A}(rₜ_{ₚ}[X′])≠θ for any X′ ⊂ X of size |X|−1. Second, to find a k-frequent variable CFD(XY→A,(tₚ,_, . . . ,_∥_)) that satisfies the conditions of the left-reduce definition, a k-frequent itemset (X,tₚ) in r must be found such that (i) Y is a minimal cover of D_{A}(rₜ_{ₚ}), i.e., Y satisfies the minimality of attributes in rᵢ_{ₚ}; and (ii) Y (resp. Y ∩ X\X′) does not cover D_{A}(rᵢ_{ₚ}_{[X′])} for any X′ ⊂ X of size |X|−1, i.e., none of the constants in tₚ[X] can be removed (resp. upgraded to ‘_’), which ensures that tₚ[X] satisfies the minimality of patterns in r. Note that in case (ii), as Y ⊂ Y ∪ X\X′, a test is done only if Y ∪ X\X′ covers D_{A}(rₜ_{ₚ}_{[X′]}) for any X′ ⊂ X of size |X|−1.

Efficient Pattern Pruning Strategy. In general, all k-frequent itemsets are considered as candidates of constant patterns in CFDs φ=(X→A,(tₚ∥_)). However, given all k-frequent free and closed itemsets, the following lemma implies that it suffices to consider only k-frequent free itemsets as candidates for constant patterns in the process of discovering minimal variable CFDs. This strategy prunes away a large part of the constant pattern candidates and significantly improves the efficiency of the disclosed technique.

Lemma 5: Let φ=(X→A,(tₚ∥_)) be a variable CFD that satisfies r|=φ and sup(φ,r)≧k. If φ is minimal then the constant pattern in tₚ, denoted by (X^{c},tₚ^{c}), is a k-frequent free itemset.

Depth-First Strategy. Assume an ordering <ₐₜₜᵣ on attr(R). FindCover maintains a list of possible k-frequent free itemsets Patt(R). The reason that only k-frequent free itemsets are considered is given in Lemma 5. For an itemset (X^{c},tₚ^{c}) in Patt(R), rₜ_{ₚ}_{^{c}} denotes the set of tuples in r that match tₚ^{c}. For each itemset (X^{c},tₚ^{c}) in Patt(R), its set of minimal difference sets produced from all tuples in rₜ_{ₚ}_{^{c}}, D_{A}(rₜ_{ₚ}_{^{c}}), is also maintained. Similar to the FastFDs algorithm, FindCover finds minimal covers of D_{A}(rₜ_{ₚ}_{^{c}}) in a depth-first, left-to-right fashion based on the ordering of attributes on attr(R)\{A}. A candidate CFDφ=(XY→A,(tₚ∥_)), where (X^{c},tₚ^{c}) is the constant part of (X,tₚ), is produced if none of the variables (i.e.,‘_’) in tₚ[X] can be removed, i.e., φ is minimal in rₜ_{ₚ}_{^{c}}. Different from the FastFDs algorithm, FindCover also ensures that the minimality conditions are checked for all subset itemsets of (X^{c},tₚ^{c}) such that none of the constants in tₚ[X] can be removed or upgraded to ‘_’. This guarantees that tₚ[X] is the most general in r.

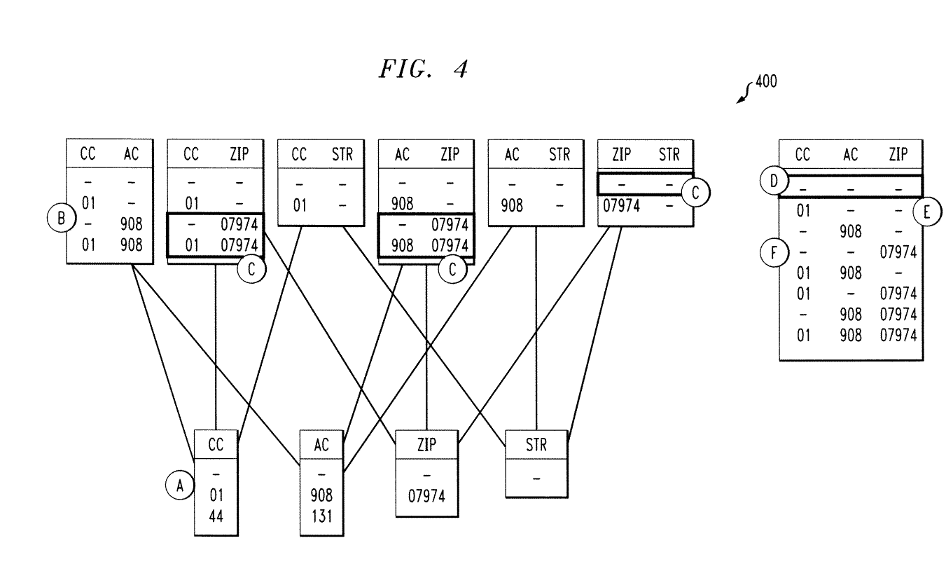

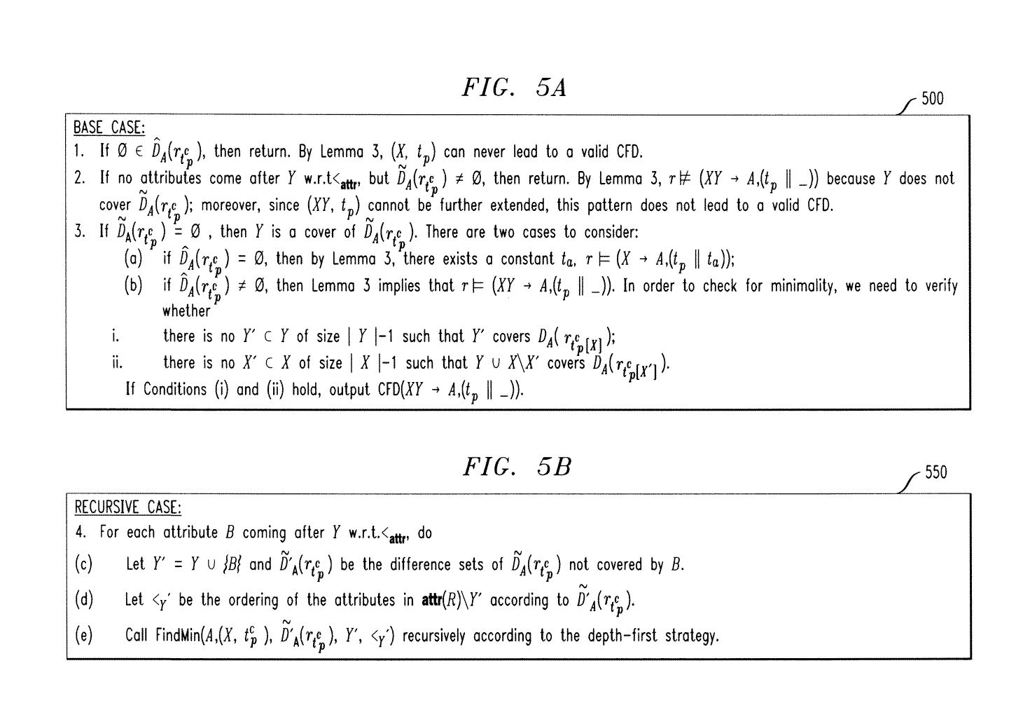

Procedure FindCover. Let A be an attribute in attr(R), and Patt(R)={(X,tₚ^{c})} the set of k-frequent patterns over attr(R) where X ⊂ attr(R). FindCoverinvokes Algorithm FindMin, discussed hereinafter in conjunction with FIGS. 5A and 5B, for each pattern (X,tₚ^{c}) ε Patt(R) until all patterns in Patt(R) are inspected.

FIGS. 5A and 5B, collectively, illustrate exemplary pseudo code for an exemplary implementation of the FindMin algorithm. D_{A}(rₜ_{ₚ}_{^{c}}) denotes the original minimal difference sets of rₜ_{ₚ}_{^{c}}, \tilde{D}_{A}(rₜ_{ₚ}_{^{c}}) ⊂ D_{A}(rₜ_{ₚ}_{^{c}}) the current difference sets not covered, which is initialized as D_{A}(rₜ_{ₚ}_{^{c}}). Y ⊂ attr(R) denotes the current path in the depth-first search tree, and <ₐₜₜᵣ the current ordering of attributes.

As shown in FIG. 5A, the exemplary base case 500 for the FindMin algorithm comprises:
1. If θ ε \hat{D}_{A}(rₜ_{ₚ}_{^{c}}), then return. By Lemma 4, (X,tₚ) can never lead to a valid CFD.
2. If no attributes come after Y w.r.t. <ₐₜₜᵣ, but \tilde{D}_{A}(rₜ_{ₚ}_{^{c}})≠θ, then return. By Lemma 4, r|≠(XY→A,(tₚ∥_)) because Y does not cover \tilde{D}_{A}(rₜ_{ₚ}_{^{c}}); moreover, since (XY,tₚ) cannot be further extended, this pattern does not lead to a valid CFD.
3. If \tilde{D}_{A}(rₜ_{ₚ}_{^{c}})=θ, then Y is a cover of \tilde{D}_{A}(rₜ_{ₚ}_{^{c}}). There are two cases to consider:
   (a) if \hat{D}_{A}(rₜ_{ₚ}_{^{c}})=θ, then by Lemma 4, there exists a constant tₐ, r|=(X→A,(tₚ∥tₐ));
   (b) if \hat{D}_{A}(rₜ_{ₚ}_{^{c}})≠θ, then Lemma 4 implies that r|=(XY→A,(tₚ∥_)). In order to check for minimality, FindMin verifies whether:
   i. there is no Y′ ⊂ Y of size |Y|−1 such that Y′ covers D_{A}(rₜ_{ₚ}_{^{c}}_{[X]});
   ii. there is no X′ ⊂ X of size |X|−1 such that Y ∪ X\X covers D_{A}(rₜ_{ₚ}_{^{c}}_{[X′]}).

If Conditions (i) and (ii) hold, output CFD(XY→A,(tₚ∥_)).

As shown in FIG. 5B, the exemplary recursive case 550 for the FindMin algorithm comprises:
4. For each attribute B coming after Y w.r.t. <ₐₜₜᵣ, do
(a) Let Y′=Y ∪ {B} and \tilde{D}_{A}′(rₜ_{ₚ}_{^{c}}) be the difference sets of \tilde{D}_{A}(rₜ_{ₚ}_{^{c}}) not covered by B.
(b) Let <_{Y′} be the ordering of the attributes in attr(R)\Y′ according to \tilde{D}_{A}′(rₜ_{ₚ}_{^{c}}).
(c) Call FindMin(A,(X,tₚ^{c}),\tilde{D}_{A}′(rₜ_{ₚ}_{^{c}}),Y′,<_{Y′}) recursively according to the depth-first strategy.

It is noted that (X′,tₚ^{c}[X′]) in Step 3.b(ii) must be a k-frequent itemset due to the anti-monotonicity property of frequent itemsets. Thus, there exist closed itemsets (Z,sₚ) such that (Z,sₚ)≦(X′,tₚ^{c}[X′]). It is noted that:

|supp(X′,tₚ^{c}[X′])|=max{|supp(Z,sₚ)|},

Thus, D_{A}(rₜ_{ₚ}_{^{c}}_{[X′]}) is the same as D_{A}(rₛ_{ₚ}_{[Z]}) where (Z,sₚ) is the closed itemset with the maximum cardinality for all (Z,sₚ)≦(X′,tₚ^{c}[X′]).

Step 4.b is an optimization that allows a dynamic reordering of the attributes while doing the depth-first traversal through the subsets of attr(R). Our algorithm supports the use of a cost model as in FastFD to dynamically reorder attributes such that attributes that cover the most difference sets are treated first.

FastCFD Illustration. As noted above, FastCFD invokes FindCover(attr(R)\{A},r,k)) for each A ε attr(R). Given a k-frequent itemset (X,tₚ^{c}) in r, FindCover invokes FindMin(A,(X,tₚ^{c}),D_{A}(rₜ_{ₚ}_{^{c}}),θ,<ₐₜₜᵣ) to produce minimal k-frequent CFDs in rₜ_{ₚ}_{^{c}}. Thus, FastCFD produces a cover of all minimal, k-frequent CFDs in r.

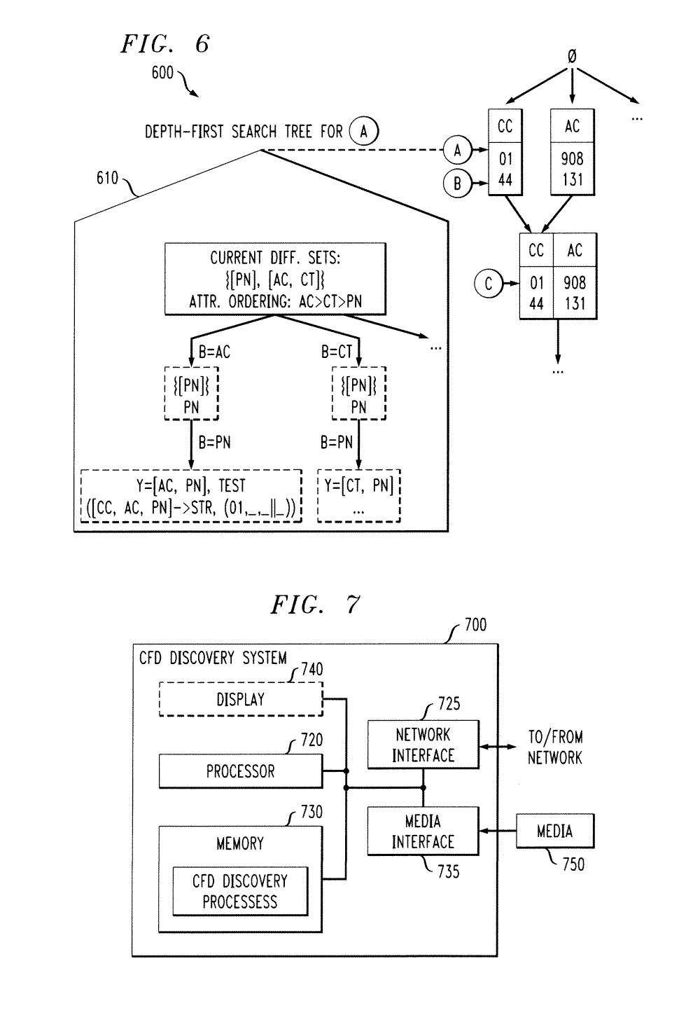

FIG. 6 illustrates a partial execution of FindCover. Consider again the cust relation of FIG. 1. FIG. 6 illustrates a partial run of FindCover(attr(R)\STR,STR,cust,2) involving only attributes CC,AC,PN,CT,ZIP and STR. (attribute NM is omitted for ease of presentation). Assume a support threshold k=2. Also, assume that <ₐₜₜᵣ is static and attributes are ordered alphabetically for simplicity of presentation. FIG. 6 illustrates the various stages of FindCover. Circled points A, B, and C are highlighted during the execution:

(A) Given a pattern (CC,01), r_{CC=01}={t₁,t₂,t₃,t₄,t₈}. The algorithm computes its minimal difference sets, i.e.,

D_{STR}(r_{CC=01})={[PN],[AC,CT]}.

The corresponding covers Y of D_{STR}(r_{CC=01}) computed in Step 3 of FindMin 500 are [AC,PN] and [CT,PN]. Those covers Y are computed in a recursive process invoked in Step 4, which is illustrated in the depth-first search tree 610 in FIG. 6. Consider the cover [AC,PN] and its minimal CFD candidate:

φ′=([CC,AC,PN]→STR,(01,_,_∥_))

in Step 3.b. Although the algorithm verifies that φ′ is minimal for r_{CC=01} in Step 3.b(i), it still needs to inspect whether [CC,AC,PN] covers D_{STR}(r) in Step 3.b(ii), where Ø is the only immediate subset of pattern (CC,01). In this case, it finds out that [CC,AC,PN] covers D_{STR}(r) which indicates that r|=([CC,AC,PN]→STR,(_,_,_∥_) Thus, φ′ is not a minimal CFD.

(B) Given a pattern (CC,44), r_{CC=44}={t₅,t₆,t₇}. The algorithm computes its difference sets, and the corresponding minimal difference sets, respectively.

\hat{D}_{STR}(r_{CC=44})={[AC,PN,CT,ZIP],[AC,CT,ZIP]}.

D_{STR}(r_{CC=44})={[AC,CT,ZIP]}

The covers of D_{STR}(r_{CC=44}) are AC, CT, and ZIP. Consider the cover AC, FindMin needs to inspect if its CFD

φ=([CC,AC]→STR,(44,_∥_))

is minimal. In Step 3.b(i), it verifies that φ is minimal for r_{CC=44}, but it still needs to inspect whether [CC,AC] covers D_{STR}(r_{Ø}) ( i.e., D_{STR}(r)) in Step 3.b(ii) where again Ø is the only immediate subset of pattern (CC,44). As shown by the cust relation, D(t₂, t₄)={PN,STR}, and [PN] ε D_{STR}(r). This implies that [CC,AC] cannot be a cover for D_{STR}(r). Thus, φ is a minimal CFD.

(C) Given a pattern tₚ^{c}=([CC, AC],[01,908]), rₜ_{ₚ}_{^{c}}={t₁,t₂,t₄}. The algorithm computes its minimal difference sets, i.e.,

D_{STR}(rₜ_{ₚ}_{^{c}})={[PN]}.

The corresponding cover of D_{STR}(rₜ_{ₚ}_{^{c}}) is [PN]. Consider its minimal CFD candidate

φ″=([CC,AC,PN]→STR,(01,908,_∥_))

in Step 3.b. Although FindMin verifies that φ″ is minimal for rₜ_{ₚ}_{^{c}} in Step 3.b(i), it still needs to inspect all immediate subsets of ([CC,AC],[01,908]), i.e., (CC,01) and (AC,908), for the minimality of φ″. Suppose that FindMin inspects (CC,01) first. It finds out that [AC,PN] is actually a cover for D_{STR}(r_{CC=01}). Thus φ″ is not a minimal CFD.

Implementation Details and Optimizations. The key differences between FastCFD and its FD-counterpart FastFD are: (1) the more complicated condition for testing the validity of a minimal CFD φ in terms of the minimality of the constant pattern and unnamed variables in LHS(φ); and (2) the fact that k-frequent CFDs are discovered instead of 1-frequent FDs only. Whereas for FDs, the only difference sets needed are D_{A}(r) for A ε attr(R), Lemma 4 states that for CFDs, difference sets D_{A}(rₜ_{ₚ}) are needed for all rₜ_{ₚ}, where tₚ is a k-frequent pattern in r. When (X,tₚ) is reached, the depth-first approach enforces FindMin to use D_{A}(rₜ_{ₚ}_{[X′]}) during the minimality check for all X′ ⊂ X of size |X|−1. All this combined implies that an efficient technique is needed for computing difference sets, in which case the following two approaches are implemented and evaluated.

NaiveFast. The first approach is inspired by the stripped partition-based approach used by FastFD (C. M. Wyss et al., “FastFDs: A Heuristic-Driven, Depth-First Algorithm for Mining Functional Dependencies from Relation Instances—Extended Abstract,” DaWak (2001)). Here, for a given (X,tₚ) the stripped partition of rₜ_{ₚ} with respect to an attribute A is the partition of rₜ_{ₚ} with respect to A from which all single-tuple equivalence classes are removed. The computation of the stripped partitions of rₜ_{ₚ} for each A ε attr(R) basically provides sufficient information to infer for any two tuples on which attributes they agree. By taking complements, one can then infer the difference sets. It is noted that the stripped partitions are often much smaller than the instances, making this approach efficient. NaiveFast is the version that relies on the partition-based approach.

FastCFD. The second approach relies on the availability of Closed₂(r), that is all 2 -frequent closed itemsets in r. Given (X,tₚ), it can be inferred for any two tuples in rₜ_{ₚ} on which attributes they agree. Indeed, these sets of attributes are given by the attributes in those itemsets in Closed₂(r) that match with tₚ^{c} (the constant part of tₚ). By taking the complement the desired difference sets can be efficiently inferred. It can be shown that this approach outperforms the partition-based approach and is therefore taken as the default implementation for difference sets in FastCFD.

Finally, since CFDMiner produces Closedₖ(r) as a side-product, CFDMiner can be used for constant CFD discovery and FastCFD can be used for variable CFDs only. For this, Step 3.a is eliminated in FindCover. This combination often leads to a very large overall improvement in efficiency.

Minimal CFDs can be discovered from a dataset r when both its arity and its size are large by sampling r (i.e., to find a subset rₛ of r by selectively drawing tuples from r such that rₛ accurately represents r and is small enough to be efficiently processed by FastCFD or CTANE).

System and Article of Manufacture Details

FIG. 7 is a schematic block diagram of an exemplary CFD discovery system 700 in accordance with the present invention. The CFD discovery system 700 comprises a computer system that optionally interacts with media 750. The exemplary CFD discovery system 700 comprises a processor 720, a network interface 725, a memory 730, a media interface 735 and a display 740. Network interface 725 optionally allows the computer system to connect to a network, while media interface 735 optionally allows the computer system to interact with media 750, such as a Digital Versatile Disk (DVD) or a hard drive. Optional video display 740 is any type of video display suitable for interacting with a human user of apparatus 700. Generally, video display 740 is a computer monitor or other similar video display. As shown in FIG. 7, the memory 730 includes the CFD discovery processes described herein.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for identifying one or more constant conditional functional dependencies defined over a schema, R, given a sample relation, r, of said schema, R, and a support threshold, k, comprising:
mining k-frequent closed itemsets and k-frequent free itemsets using a latest mining technique following a depth-first search scheme, wherein said one or more constant conditional functional dependencies comprise only constant patterns.

2. The method of claim 1, further comprising the steps of:
obtaining k-frequent closed itemsets and one or more corresponding k-frequent free itemsets;
for each k-frequent closed itemset:
(i) adding one or more corresponding free itemsets to a hash table H; and
(ii) associating a candidate itemset with each of said corresponding free itemsets, wherein said candidate itemset comprises candidate attributes in their corresponding constant conditional functional dependencies;
maintaining an ordered list L of all k-frequent free itemsets (Y,sₚ), wherein said ordered list is ordered based on size; and
processing said ordered list L by replacing RHS(Y,sₚ) with RHS(Y,sₚ) ∩ RHS(Y′,sₚ[Y′]) for each subset Y′Y such that (Y′,sₚ[Y′]) ε L.

3. The method of claim 1, wherein said identified conditional functional dependencies are minimal conditional functional dependencies that substantially do not contain redundant attributes or redundant patterns.

4. The method of claim 1, wherein said identified conditional functional dependencies are frequent conditional functional dependencies in which the pattern tuples have a support in r above a certain threshold.

5. A method for identifying one or more conditional functional dependencies defined over a schema, R, given a sample relation, r, of said schema, R, and a support threshold, k, comprising:
generating an attribute set/pattern lattice comprised of attribute/value pairs that appear at least k times, wherein each attribute occurs with an unnamed variable; and
employing a levelwise approach to mine said conditional functional dependencies at each level k+1 of said lattice, wherein each set at said level k+1 consists of k+1 attributes; and
pruning said lattice based on attributes at level k.

6. The method of claim 5, wherein said generating step computes candidate RHS for minimal conditional functional dependencies with their LHS in said lattice, Lₗ.

7. The method of claim 5, wherein said identified conditional functional dependencies are minimal conditional functional dependencies that do not contain redundant attributes or redundant patterns.

8. The method of claim 5, wherein said identified conditional functional dependencies are frequent conditional functional dependencies in which the pattern tuples have a support in r above a certain threshold.

9. The method of claim 5, wherein said pruning step prevents a creation of inconsistent conditional functional dependencies.

10. The method of claim 5, wherein said pruning step ensures that a LHS cannot be reduced.

11. The method of claim 5, wherein said pruning step ensures that said pattern tuple is substantially most general.

12. A method for identifying one or more conditional functional dependencies defined over a schema, R, given a sample relation, r, of said schema, R, and a support threshold, k, comprising:
identifying a set of k-frequent patterns in said schema:
for each identified k-frequent pattern, maintaining a set of minimal difference sets;
identifying minimal covers of said minimal difference sets using a depth-first approach based on an ordering of attributes;
producing a candidate conditional functional dependency if no variable in said patterns can be removed; and
evaluating one or more minimality conditions for each identified k-frequent pattern.

13. The method of claim 12, further comprising a pruning step that employs constant conditional functional dependencies.

14. The method of claim 12, wherein said identified conditional functional dependencies are minimal conditional functional dependencies that do not contain redundant attributes or redundant patterns.

15. The method of claim 12, wherein said identified conditional functional dependencies are frequent conditional functional dependencies in which the pattern tuples have a support in r above a certain threshold.
